(19) United States
(12) Patent Application Publication
(10) Pub. No.: US 2013/0216877 A1
(43) Pub. Date: Aug. 22, 2013

(54) BATTERY FLUID LEVEL SENSOR

(71) Applicant: TOUCHSENSOR TECHNOLOGIES, LLC, (US)

(72) Inventor: Robert B. Campbell, Naperville, IL (US)

(73) Assignee: TOUCHSENSOR TECHNOLOGIES, LLC, Wheaton, IL (US)

(21) Appl. No.: 13/770,840

(22) Filed: Feb. 19, 2013

Related U.S. Application Data
(60) Provisional application No. 61/600,929, filed on Feb. 20, 2012.

(51) Int. Cl. H01M 10/48

(52) U.S. Cl. CPC H01M 10/484
USPC 429/91

(57) ABSTRACT

A liquid electrolyte battery incorporates level sensors sensing and providing an output indicative of the presence or absence of electrolyte or other liquid proximate the sensors. The sensors can be self-powered or powered by the battery or by a separate battery.

### CROSS-REFERENCE TO RELATED APPLICATION

This application claims priority from U.S. Provisional Patent Application No. 61/600,929, filed on Feb. 20, 2012, and incorporates by reference the entire disclosure thereof.

### BACKGROUND OF THE INVENTION

The present invention is directed to fluid level sensor apparatus that might be used in connection with liquid electrolyte batteries, for example, lead acid batteries and the like.

Deep cycle lead acid batteries, as might be used in marine, forklift, and emergency applications, are deeply discharged through normal use and subsequently recharged on a regular basis. The charging process can, over time, generate a substantial amount of hydrogen gas and deplete a substantial amount of electrolyte from the battery. As such, deep cycle batteries typically are not ideal candidates for sealed construction.

Maintaining a proper electrolyte level is important to the operation and longevity of such a battery. Monitoring electrolyte level, however, can be cumbersome because the batteries often are inconveniently located. Conventional level sensors, when used in a conventional manner, are subject to corrosion resulting from contact with the electrolyte and, therefore, are less than ideal for remotely monitoring electrolyte level.

### BRIEF DESCRIPTION OF THE DRAWINGS

FIG. 1 is a perspective view of an illustrative liquid electrolyte battery 10 having a housing 12, side walls 14, top 16, fill caps 18, posts 20 and cells A-F;

FIG. 2 is a perspective view of battery 10 with fill caps 18 removed, thereby exposing fill holes 22A-22F;

FIGS. 3A and 3B are perspective views of battery 10 having six sensors 24A-24F disposed on a substrate 26 attached to side wall 14 thereof;

FIGS. 4A and 4B are perspective views of battery 10 having six discrete sensors 24A-24F disposed on corresponding discrete substrates 26A-26F attached to side wall 14 thereof;

FIG. 5 is a perspective view of a sensor 24 encapsulated within a dipstick 28 depending from a fill cap 18; and

FIG. 6 is a front elevation view of a substrate 26 bearing six sensors 24A-24F and a battery holder 34.

### DETAILED DESCRIPTION OF THE DRAWINGS

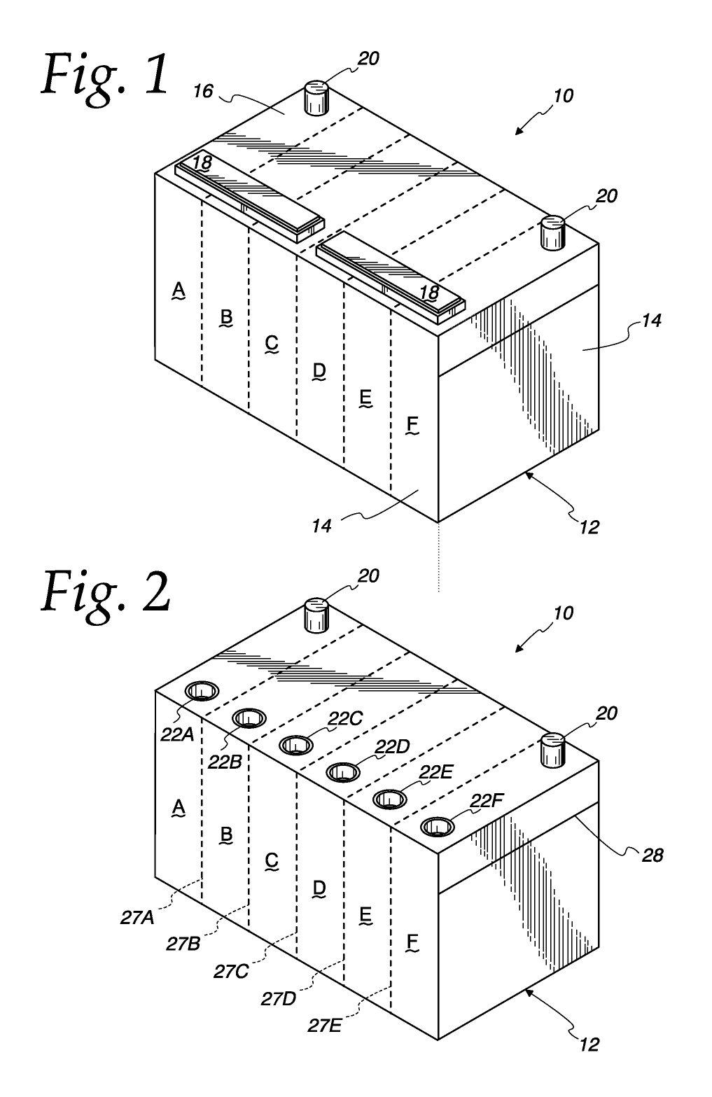

FIGS. 1 and 2 illustrate a liquid electrolyte battery 10 having a housing (or tray) 12. Housing 12 includes a side wall 14, a top 16, and a bottom (not shown). Battery 10 includes six cells A-F and two terminal posts 20. Barriers 27A-27E internal to housing 12 separate cells A-F from each other, as would be recognized by one skilled in the art. Each cell A-F, in essence, forms a unique and distinct container independent of each other cell A-F. Each of cells A-F typically includes a pair of plates made of lead or another metal. Top 16 of housing 12 defines a fill hole 22A-22F for each cell A-F through which electrolyte (for example, sulfuric acid) or water can be added to battery 10. Caps 18 are provided to close (for example, plug and/or cover) fill holes 22A-22F. Battery 10 may have an optimal electrolyte fill level as indicated by fill line 28.

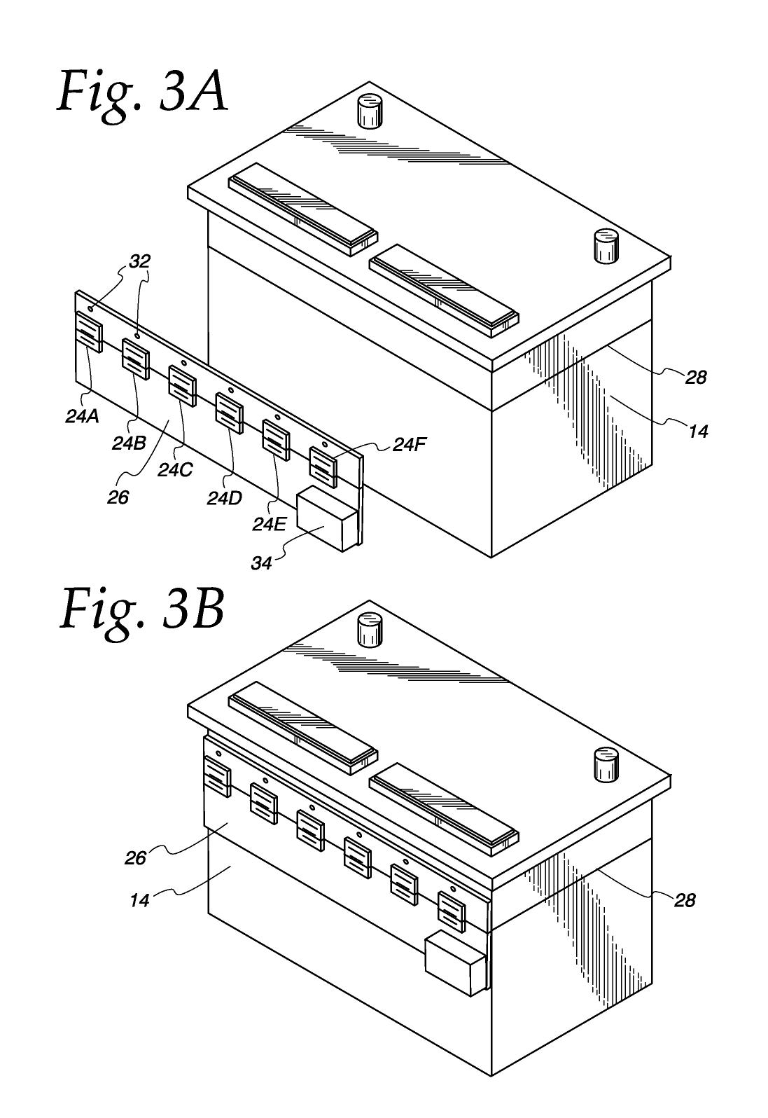

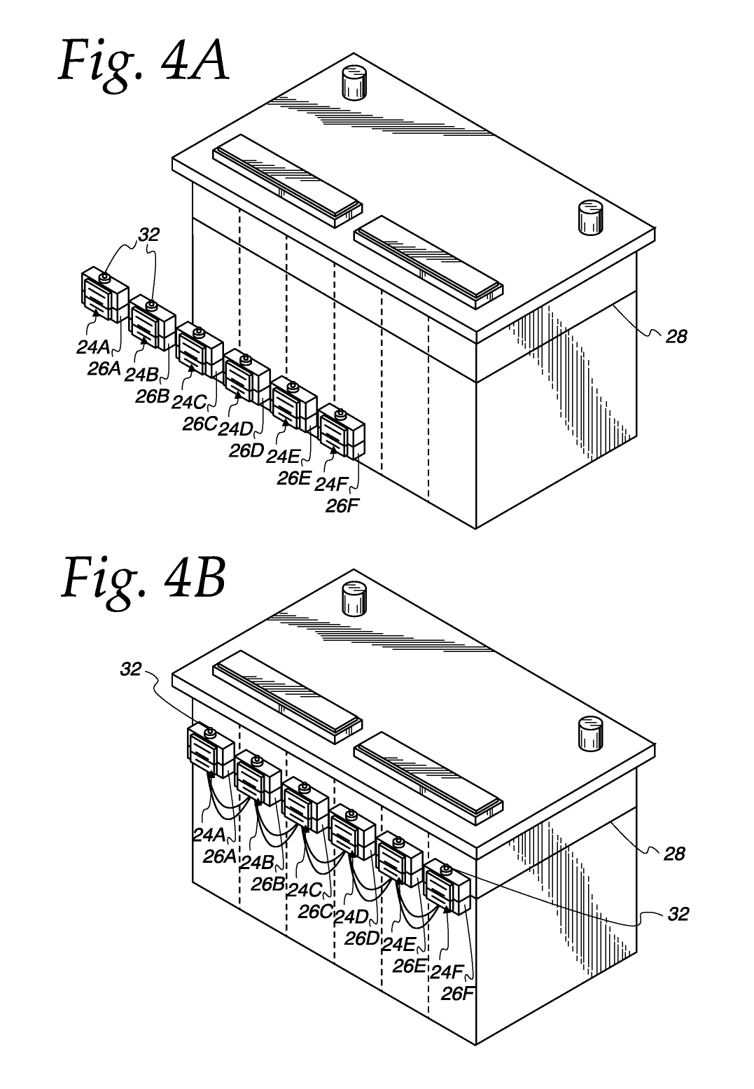

One or more non-contact proximity sensors can be provided in association with any or all of cells A-F. For example, FIGS. 3A-3B and 4A-4B illustrate sensors 24A-24F associated with corresponding cells A-F. In other embodiments, sensors 24 could be provided in association with fewer than all of cells A-F. For example, a sensor 24 could be provided in association with only any one, two, three, four or five of cells A-F. In further embodiments, more than one sensor 24 could be provided in association with any or all of cells A-F. In embodiments using more than one sensor per cell, the several sensors per cell could be located at the same height to provide redundancy or they could be located at different heights to provide further, more discrete level indication. For example, several sensors 24 could be located so as to provide for detection of normal, high, and/or low electrolyte level within a particular cell or cells A-F.

FIGS. 3A, 3B and 6 show sensors 24A-24F disposed in an array on a surface of substrate 26. Substrate 26 could be attached to housing 12 with sensors 24A-24F facing away from housing 12 or such that sensors 24A-24F are sandwiched between substrate 26 and housing 12. Alternatively, sensors 24A-24F could be encapsulated within substrate 26. In either embodiment, the sensor pitch, that is, the spacing between sensors 24A-24F on substrate 26, preferably is such that each of sensors 24A-24F aligns with a portion of a corresponding cell A-F. Although all of sensors 24A-24F are shown as being disposed on a single substrate 26, the sensors could be divided among two or more substrates 26, with at least one sensor 24 disposed on each such substrate 26. As shown in FIG. 3B, substrate 26 can be attached to side wall 14 of battery 10 such that each of sensors 24A-24F is located in a position from which it can detect the presence or absence of electrolyte or another liquid in corresponding cells A-F at a predetermined level of housing 12, as will be discussed further below. For example, sensors 24A-24F can be located so that they can detect the presence or absence of electrolyte or another liquid proximate the level of fill line 28 or at any other predetermined level.

FIGS. 4A and 4B shows sensors 24A-24F disposed on individual substrates 26A-26F. Substrates 26A-26F could be attached to housing 12 with sensors 24A-24F facing away from housing 12 or such that sensors 24A-24F are sandwiched between substrates 26A-26F and housing 12. The attachment could be facilitated using double-sided tape, adhesive strips, glues, and the like. For example, substrate(s) 26 could be provided with one surface of an adhesive strip or double-sided tape applied thereto and the other surface of the strip or tape covered with a removable backing. With the backing removed, the assembly could be attached to the side of housing 12. Alternatively, sensors 24A-24F could be encapsulated within substrates 26A-26F. In either embodiment, as shown in FIG. 4B, substrates 26A-26F can be attached to side wall 14 of battery 10 such that each of sensors 24A-24F is located in a position from which it can detect the presence or absence of electrolyte or another liquid in corresponding cells A-F at a predetermined level relative to housing 12, as will be discussed further below. For example, sensors 24A-24F can be located so that they can detect the presence or absence of electrolyte or another liquid proximate the level of fill line 28 or any other predetermined level.

In other embodiments (not shown), substrates 26 could be omitted and sensors 24 could be disposed directly on housing 12 at a predetermined level, as discussed further above. For example, sensors 24 could be disposed directly on the outer side of side wall 14. Alternatively, sensors 24 could be disposed on an interior surface of housing 12. In further embodiments (not shown), sensors 24 could be encapsulated within side wall 14.

In embodiments wherein sensors 24 are disposed on a surface of a substrate 26 or a surface (interior or exterior) of housing 12, sensors 24 preferably would be covered with a material or overlay suitable for protecting sensors 24 from mechanical, corrosive and/or other damage. In embodiments wherein sensors 24 are encapsulated within a substrate 26 or housing 12 (for example, within side wall 14), the substrate/housing material within which sensors 24 are encapsulated could be sufficient to protect sensors 24 from such damage. Notwithstanding, additional protection could be provided to further protect sensors 24 from damage.

In all of the foregoing embodiments, sensors 24 preferably are located so as to minimize or eliminate air gaps between sensors 24 and the interior of housing 12.

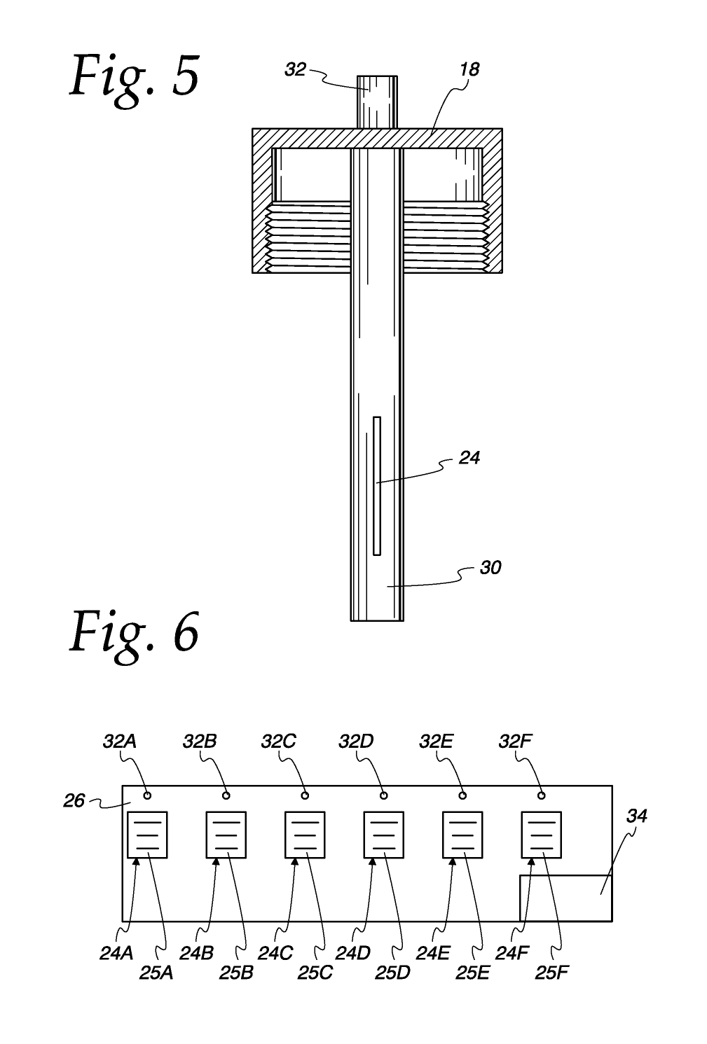

FIG. 5 illustrates a sensor 24 encapsulated within a dip stick 28 extending from the underside of fill cap 18′. In other embodiments, sensor 24 could be disposed on a surface of dip stick 30. In such embodiments, sensor 24 preferably would be covered with a material suitable to protect sensor 24 from mechanical, corrosive and/or other damage. Sensor 24 preferably would be located on dip stick 30 such that sensor 24 would be at a predetermined level within a corresponding cell A-F when fill cap 18 is installed to housing 12, thereby plugging fill hole 22. For example, sensor 24 could be located such that it could sense the presence or absence of electrolyte within a corresponding cell A-F proximate the level of fill line 28 or any other predetermined level.

Sensors 24 can be embodied as any form of sensor suitable for detecting the proximity of an electrolyte that might be used in battery 10. For example, sensors 24 could be capacitive sensors or field effect sensors as would be known to one skilled in the art. Such sensors typically include a sensor cell having one or more electrodes and a control circuit for providing excitation signals to the sensor cell and detecting changes in capacitance or other electrical properties relating to the sensor cell in response to touch or proximity of an object. One suitable form of sensor is the TS-100 sensor marketed by TouchSensor Technologies of Wheaton, Ill. The structure and operation of this sensor is disclosed in commonly owned U.S. Pat. No. 6,320,282, the disclosure of which is incorporated herein by reference. The TS-100 sensor includes a sensor cell having one or more sensing electrodes and an integral control circuit located in close proximity to the sensor cell.

As shown in FIG. 6, each of sensors 24A-24F includes a sensor cell having a generally square sensing electrode 25A-25F having a grid-like configuration. In other embodiments, a second sensing electrode could partially or substantially surround each of sensing electrodes 25A-25F. In further embodiments, the sensor cells and/or sensing electrodes could have other configurations. For example, they could have a generally elongate form or any other suitable solid, open or semi-open form.

Electrical power for the operation of sensors 24 and associated circuitry can be provided from numerous sources and in various ways. For example, electrical power could be provided to sensors 24 from battery 10 by coupling the power terminals of sensors 24 to battery posts 20 outside housing 12 (an external connection), inside housing 12 (an internal connection) or from within housing 12 (a through-wall connection) of battery 10. External connections might be convenient with embodiments wherein sensors 24 are located external to housing 12, for example, where sensors 24 are located on substrates 26 attached to housing 12 or disposed directly on an outer surface of housing 12. External connections could be used with other embodiments, as well. For example, external connections could be used with the dipstick embodiment of FIG. 5. Internal connections might be convenient with embodiments wherein sensors 24 are disposed on an inner surface of housing 12, but internal connections could be used in other embodiments, as well. Through-wall connections might be convenient with embodiments wherein sensors 24 are encapsulated within side wall 14 of housing 12, but through-wall connections could be used in other embodiments, as well.

Alternatively, sensors 24 could be powered from an external source, that is, a source electrically independent of the battery sensors 24 are intended to monitor. For example, sensors 24 could be powered by one or more self-contained auxiliary batteries or other power sources that could (but need not) be dedicated to operation of sensors 24 and associated circuitry. Such auxiliary batteries could be provided in connection with each of individual sensors 24 or arrays of sensors 24. Substrate(s) 26 could include a battery holder 34 for receiving such batteries, as shown, for example, in FIG. 6. Sensors 24 could be powered by other external sources, as well. The sensing circuit of such an embodiment could be designed such that the quiescent current is extremely low, for example, 2 μA or less, with favorable duty cycles, in order to reduce or minimize average power usage and battery drain.

In other embodiments, sensors 24 could be self powered. More particularly, sensors 24 could be connected to electrodes of dissimilar metals. The electrodes could be immersed in or otherwise in contact with the electrolyte within battery 10. The electrolyte and electrodes would form a battery for powering sensors 24. This means for self-powering could be particularly convenient in connection with the dip stick embodiment of FIG. 5.

Sensors 24 can provide an electrical output that can be used to provide an indication of electrolyte level within one or more cells A-F of battery 10. For example, the output could be associated with an indicator light 32 that might be extinguished when sensor 24 detects the proximity of electrolyte and that illuminates when sensor 24 does not detect the proximity of electrolyte or vice versa. Alternatively, the output could, for example, cause a green light to illuminate when sensor 24 detects the proximity of electrolyte and cause a red light to illuminate when sensor 24 does not detect the proximity of electrolyte. An alarm could be provided instead of or in addition to the indicator light. The indicator light and/or alarm could be located locally at or near the sensor or battery. For example, in the FIGS. 3A-3B and 4A-4B embodiments, one or more indicator lights 32 could be located in or on substrate 26 adjacent a corresponding sensor, as shown, for example, in FIG. 6. In the FIG. 5 embodiment, an indicator light 32 could be disposed on dip stick 30. Alternatively or additionally, the indicator light and/or alarm could be located remotely, for example, on a vehicle dashboard.

Any or all of sensors 24A-24F could be electrically independent from each other as shown, for example, in FIG. 4A. Alternatively, any or all of sensors 24A-24F could be electrically connected as shown, for example, in FIG. 4A. In embodiments wherein sensors 24A-24F are electrically connected, the electrical interconnection could be embodied so as to power any or all of the interconnected sensors from a common source and/or in the form of a communications bus for transmitting the sensor outputs to other circuitry. Sensors 24A-24F could be similarly electrically independent or connected in other embodiments, for example, the embodiment of FIGS. 3A-3B wherein all of sensors 24A-24F are mounted on a common substrate 26.

One skilled in the art would recognize that sensors 24-24F generate electrical fields about their electrodes. Sensors 24A-24F preferably are tuned so that these electric fields electrically couple to the electrolyte within battery when the electrolyte is proximate the respective sensor 24A-24F. The sensors respond to the presence, absence, magnitude and/or relative change of these couplings such that the sensors have a first output state when electrolyte is present proximate the sensors and a second output state when electrolyte is not present proximate the sensors. One skilled in the art also would recognize that these electric fields could, under some circumstances, electrically couple to the metal plates inside battery 10. As such, the sensors should be tuned so that any such coupling with the metal plates does not substantially interfere with or render the coupling to the electrolyte ineffective to change the state of the sensor in response to presence or absence of electrolyte proximate the sensor. In order to facilitate such tuning, battery 10 preferably is constructed so that there is at least some minimum distance between the metal plates and sidewall 14 of housing 10 such that sensors 24 can be tuned to couple primarily to the electrolyte, rather than to the metal plates. Similar considerations apply in embodiments, for example the FIG. 5 embodiment, wherein sensor 24 is disposed in a dip stick 28 or probe extending into a cell of battery 10. In such embodiments, the fill hole of battery 10 into which the probe is inserted preferably is located such that there is at least some minimum distance between the metal plates and the probe when the probe is inserted into battery 10.

Although certain features may have been discussed herein in connection with only a specific embodiment, it is to be understood that the any of the features disclosed in connection with a specific embodiment generally could be used in connection with any other embodiment. Also, although battery 10 has been described as a battery having six cells A-F, battery 10 could have more or fewer than six cells, and the construction details of battery 10 and implementation of sensors 24 thereon could be modified accordingly, as would be recognized by one skilled in the art

1. An apparatus comprising:
a battery comprising a housing having a bottom and a side wall, said housing defining at least one cell;
a sensor comprising a sensor cell associated with a portion of said housing adjoining said cell;
said sensor adapted to detect and provide an output indicative of the presence or absence of an electrolyte in said cell proximate said portion of said housing.

2. The apparatus of claim 1 wherein said sensor is associated with said side wall.

3. The apparatus of claim 2 wherein said sensor is adhered to said side wall.

4. The apparatus of claim 2 wherein said sensor is disposed within said side wall.

5. The apparatus of claim 1 wherein said battery provides power to said touch sensor.

6. The apparatus of claim 5 further comprising an electrical connection between said sensor and a post and/or a cell plate of said battery for providing power to said touch sensor.

7. The apparatus of claim 1, said apparatus further comprising a second sensor associated with a second portion of said housing adjoining said cell, said second sensor adapted to detect and provide an output indicative of the presence or absence of said electrolyte within said cell.

8. The apparatus of claim 7 wherein said sensor is located higher than said second sensor with respect to said bottom of said housing.

9. The apparatus of claim 1 wherein said housing defines at least one additional cell, and said apparatus comprises at least one additional sensor, each said at least one additional sensor corresponding to a respective at least one additional cell, each said at least one additional sensor associated with a portion of said housing corresponding to a respective at least one additional cell, and each said at least one additional sensor adapted to detect and provide an output indicative of the presence or absence of an electrolyte in said respective at least one additional cell proximate said portion of said housing corresponding to said respective at least one additional cell.

10. The apparatus of claim 9 wherein said sensor said at least one additional sensor are disposed on a single substrate, said substrate attached to said side wall of said housing.

11. The apparatus of claim 1 wherein said output of said sensor is coupled to structure providing visual and/or audible indication that said sensor has detected or has not detected the presence of electrolyte.

12. The apparatus of claim 1 wherein said sensor further comprises a first power electrode made of a first material and a second power electrode made of a second material, such that immersion of said electrodes in said electrolyte causes a voltage to be produced across a junction of said first and second power electrodes.

13. The apparatus of claim 1 wherein said sensor cell comprises a first sensing electrode.

14. The apparatus of claim 13 wherein said sensor cell further comprises a second sensing electrode proximate said first sensing electrode.

15. The apparatus of claim 14 wherein said second sensing electrode substantially surrounds said first sensing electrode.

16. The apparatus of claim 1 wherein said sensor further comprises an integral control circuit proximate said sensor cell.

17. The apparatus of claim 16 wherein said integral control circuit is unique to said sensor.

18. The apparatus of claim 1 wherein said sensor is powered by a source other than said battery.

19. The apparatus of claim 1 further comprising an auxiliary battery, said auxiliary battery providing power to said sensor.

20. An apparatus comprising:
a substrate;
a plurality of sensors associated with said substrate, each said sensor adapted to detect and provide an output indicative of the presence or absence of a liquid electrolyte in a corresponding, distinct container in proximity to said substrate; and
a self-contained power source coupled to and providing power to said plurality of sensors.
